(19) United States
(12) Patent Application Publication
(10) Pub. No.: US 2006/0288188 A1
(43) Pub. Date: Dec. 21, 2006

(54) Translating a string operation

(75) Inventors: Guokai Ma, Shanghai (CN); Jianhui Li, Shanghai (CN)

Correspondence Address: TROP PRUNER & HU, PC, 1616 S. VOSS ROAD, SUITE 750, HOUSTON, TX, 77057-2631, US

(73) Assignee: Intel Corporation

(21) Appl. No.: 11/155,376

(22) Filed: Jun. 17, 2005

(51) Int. Cl. G06F 12/00

(52) U.S. Cl. 711/201

(57) ABSTRACT

A technique includes performing multiple aligned accesses to a memory to retrieve data of a string misaligned with respect to boundaries of the memory by an offset. Based on the offset, a subset of the data is selected, and the subset is stored in a register.

### BACKGROUND

The invention generally relates to translating a string operation.

A read or write operation that targets a particular memory address typically is considered aligned when the address is a multiple of the length (in bytes) of the data that is being retrieved (for the read operation) or stored (for the write operation). For example, a write operation to store a double Dword (eight bytes) in a memory location is aligned if the address of the write operation is exactly divisible by eight.

More specifically, referring to FIG. 1, a 64-bit architecture computer system may include memory that has double Dword address boundaries 14. Thus, a double Dword that is located within the confines of the double Dword address boundaries 14 may be efficiently retrieved using a single aligned read operation. However, retrieving a double Dword 18 that spans across the double Dword boundaries 14 is relatively less efficient as two, instead of one, memory operations are used to retrieve the double Dword 18: a first aligned memory read operation to retrieve a double Dword 10 that contains part 18a of the double Dword 18 and a subsequent aligned memory read operation to retrieve a double Dword 12 that contains the remaining portion 18b of the double Dword 18.

A typical computer system processes strings, such as source strings that provide multiple scalar inputs or destination strings that contain multiple scalar outputs for such operations as multiple, add and divide operations (as examples). The memory address boundaries (for purposes of determining alignment) are determined from the size of the string element. For example, for a string element that has a four byte size, memory address four would be considered a memory boundary. However, if the string element that has an eight byte size, then memory address four is not considered a memory boundary.

A misaligned string may cause performance difficulties and may produce incorrect processing results for an architecture that does not handle misaligned memory accesses or handles such accesses with a relatively low efficiency. Thus, there is a continuing need for an arrangement and/or technique that allows efficient memory accesses for misaligned strings.

### BRIEF DESCRIPTION OF THE DRAWING

FIG. 1 is an illustration of a memory organization of the prior art.

FIG. 2 is a block diagram of a computer system according to an embodiment of the invention.

FIG. 3 illustrates a string stored in memory according to an embodiment of the invention.

FIG. 4 depicts a time sequence in which elements of the string are retrieved from the memory in accordance with an embodiment of the invention.

FIG. 5 is a flow diagram depicting a technique to translate a misaligned string operation in accordance with an embodiment of the invention.

FIG. 6 is a flow diagram depicting a technique to retrieve aligned and misaligned strings from a memory according to an embodiment of the invention.

FIG. 7 is a flow diagram depicting a technique to store aligned and misaligned strings in a memory according to an embodiment of the invention.

FIG. 8 is a more detailed flow diagram depicting retrieval of aligned and misaligned source strings from the memory in accordance with an embodiment of the invention.

FIG. 9 is a flow diagram depicting a more detailed technique to store aligned and misaligned strings in a memory according to an embodiment of the invention.

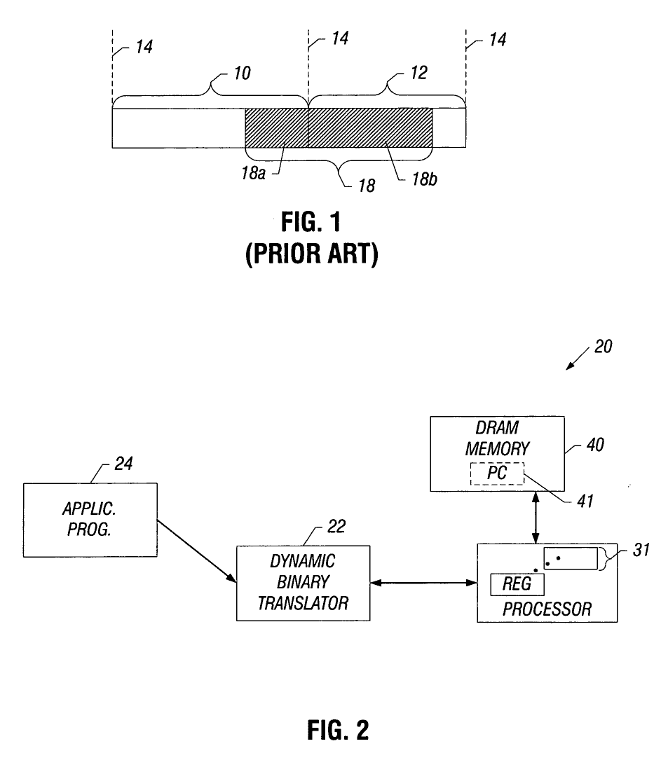

### DETAILED DESCRIPTION

Referring to FIG. 2, in accordance with an embodiment 20 of the invention, a computer system includes a processor 30 (one or more microprocessors, for example) that uses a dynamic binary translator 22 for purposes of executing an application program 24. As a more specific example, the processor 30 may have an architecture (a 64-bit architecture, for example) that is different from an architecture (32-bit architecture, for example) for which the application program 24 was written. However, the dynamic binary translator 22 (via its execution by the processor 30) translates strings of the application program 24 for execution by the processor 30.

More specifically, the architectural differences between the system for which the application program 24 was written and the architecture of the processor 30 may be significantly different enough to cause execution errors if the processor 30 were to execute the application program 24 directly. For example, if not for the dynamic binary translator 22, the application program 24 present misaligned source and destination strings that the processor 30 may refuse to execute. Although the application program 24 may have been written for an architecture that allows for such processing, the architecture of the computer system 20 may not support such features.

As a more specific example, the application program 24 may be written to execute on a 32-bit processor architecture. However, the processor 30 may have a 64-bit architecture, an architecture that creates double Dword accesses (i.e., 64-bit accesses) to a memory 40 (a dynamic random access memory (DRAM), for example) and thus, establishes double Dword boundaries in the memory 40 for Dword accesses. Although the processor's architecture may permit single byte access to the memory 40, the architecture may not support double Dword accesses to the memory 40 at addresses other than addresses that coincide with the double Dword boundaries.

For each string element operation, the processor 30 acts upon source strings that are stored in one or more registers 31 of the processor 30. As a result of the string operation, the processor 30 stores destination strings in one or more the registers 31.

Because the application program 24 may be written for an architecture that allows misaligned source and destination strings, the dynamic binary translator 22 effectively translates these strings so that the strings are seen as aligned strings by the processor 30. Although one solution may be translating a multibyte operation so that the processor 30 operates on single bytes, this solution may not be efficient. Therefore, in accordance with embodiments of the invention, the dynamic binary translator 22, as described below, performs a pipeline operation for purposes of retrieving a misaligned source string from the memory 40 and storing the string into the registers 31 so that when stored in the registers 31, the strings are perceived by the processor 30 as being aligned with the double Dword boundaries. Additionally, in accordance with embodiments of the invention, the dynamic binary translator 22 uses a pipeline operation to store a misaligned destination string (i.e., a string that is produced by an operation) in the memory 40.

It is noted that is some embodiments of the invention, the dynamic binary translator 22 may be stored in the memory 40 as program code 41, which is executed by the processor 30 to cause the computer system 20 to perform the various string translation operations that are described herein. The computer system 20 may stored program code for the dynamic binary translator 22 in one or more other storage media, in other embodiments of the invention. Furthermore, all or part of this program code may be stored on removable media, in some embodiments of the invention. Thus, many variations are possible and are within the scope of the appended claims.

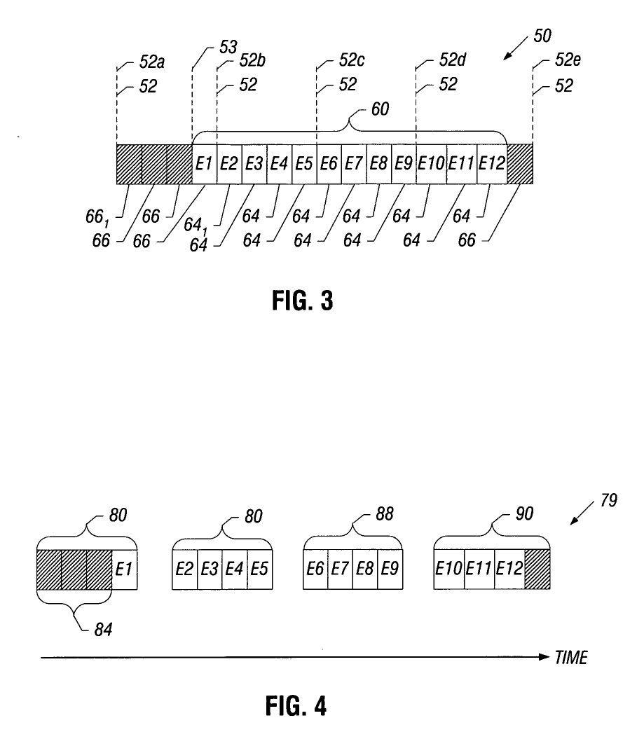

FIG. 3 depicts a portion 50 of the memory 40 (see FIG. 2), illustrating a string 60 (herein called a “misaligned string 60”) that is misaligned with respect to double Dword address boundaries 52 (address boundaries 52a, 52b, 52c, 52d and 52e, being depicted as examples). It is noted that the string 60 may be a source string or a destination string.

For this example, the string 60 occupies twelve memory units in the memory 40, which may be (for purposes of this example) two bytes each: memory units E1, E2, E3, E4, E5, E6, E7, E8, E9, E10, E11 and E12. Each memory unit of the string 60 is stored in a corresponding contiguous memory location 64 of the memory 40 (FIG. 2). The string 60, for this example, has three double Dword elements (element “E1E2E3E4,” element “E5E6E7E8,” and element “E9E10E11E12).

As shown in FIG. 3, the string 60 is misaligned with respect to the double Dword address boundaries 52. In other words, the memory location 64ₗ (i.e., a specific one of the memory locations 64) that stores the beginning of the element “E1E2E3E4” is not aligned with one of the boundaries 52. Instead, the memory unit E1 is stored at an address 53 that is located between the address boundaries 52a and 52b at an offset from the boundary 52a. As also depicted in FIG. 3, for this example, the region of the memory 40 between the address boundaries 52a and 52b contains additional locations 66 in which memory units of the string 60 are not stored. Thus, if the string 60 were aligned with respect to the boundaries 52, the memory unit E1 would be stored in the location 66ₗ (i.e., a specific one of the memory locations 66).

In accordance with the embodiments of the invention, the dynamic binary translator 22 (FIG. 2) performs pipeline operations for purposes of retrieving misaligned strings from the memory 40 and storing these strings in the register(s) 31 of the processor 30 (FIG. 2). As a more specific example, FIG. 4 depicts a time sequence 79 in which the string 60 is retrieved from the memory 40. Aligned double Dword read operations are used to retrieve the string 60. More specifically, referring to FIG. 4 in conjunction with FIGS. 2 and 3, in a first read operation 80, the double Dword between the address boundaries 52a and 52b (FIG. 3) is retrieved from the memory 40 (FIG. 2). Thus, the read operation 80 retrieves three memory units 84 that do not contain any part of the string 60 and the E1 memory unit. Subsequently, a second read operation 86 is performed to retrieve a double Dword that contains the E2, E3, E4 and E5 memory units. Next, a read operation 88 is performed to retrieve the E6, E7, E8 and E9 memory units. Lastly, a read operation 90 is performed to retrieve the E10, E11 and E12 memory units, along with a memory unit 94 that does not contain any element of the string 60. As further described below, the dynamic binary translator 22 (FIG. 2) uses a pipeline operation to extract selected memory units from each read operation and combine the selected units with selected memory units of the previous read operation for purposes of creating an aligned string to be processed by the processor 30 (FIG. 2).

More specifically, in accordance with some embodiments of the invention, the elements of the exemplary string 60 may be combined and stored in the register(s) 31 in the following manner. It is first noted that the first E1 memory unit is preceded in memory locations by three memory units 84. This offset of three, in turn, is used when combining the elements for storage in the register(s) 31. In this regard, the read operations 80 and 86 are first performed for purposes of extracting the string element E1E2E3E4. Thus, after the read operation 86, the memory unit E1 from the first read operation 80 and memory units E2, E3 and E4 from the second read operation 86 are combined to derive the string element E1E2E3E4 that is stored in the register(s) 31 in the same manner as if the string element E1E2E3E4 was obtained in the same read operation. Memory unit E5 from the second read operation 86 is combined with memory units E6, E7 and E8 from the third read operation 88 for purposes of forming the string element E5E6E7E8, which is stored in the register(s) 31. Likewise, memory unit E9 from the third read operation 88 is combined with memory units E10, E11 and E12 from the fourth read operation 90 for purposes of forming the string element E9E10E11E12 that is stored in the register(s) 31.

Therefore, in effect, the above-described pipeline operation by the dynamic binary translator 22 makes it appear to the processor 30 that the string 60 is aligned in the memory 40. In other words, due to the above-described pipeline operation by the dynamic binary translator 22, the retrieval of the string 60 from the memory 40 appears as if the string element E1E2E3E4 was obtained in a first read operation; the string element E5E6E7E8 was obtained in a subsequent second read operation; and the string element E9E10E11E12 was obtained in a subsequent third read operation.

Thus, the dynamic binary translator 22 uses aligned accesses for purposes of retrieving source strings from the memory 40. As further described below, the dynamic binary translator 22 maximizes the number of aligned accesses for purposes of storing a destination string in the memory 40.

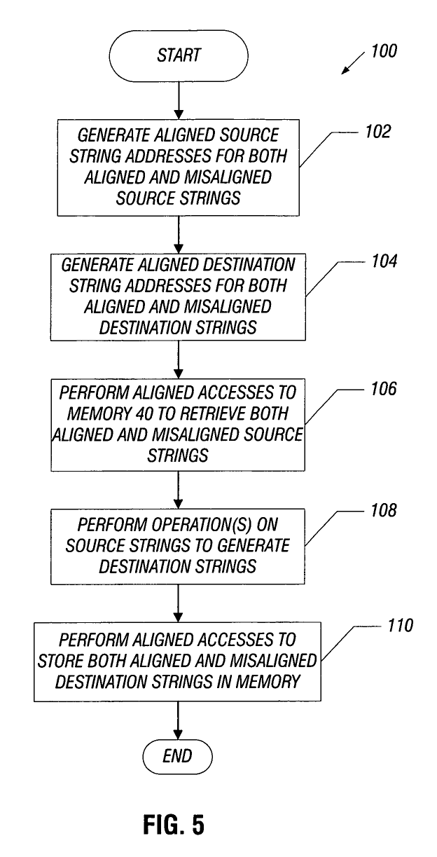

Referring to FIG. 2 in conjunction with FIG. 5, in accordance with some embodiments of the invention, the dynamic binary translator 22 generally performs a technique 100 for purposes of loading and unloading source and destination strings, respectively, into and out of the processors register(s) 31. The dynamic binary translator 22 first generates (block 102) aligned source string addresses for both aligned and misaligned strings; and then the translator 22 subsequently generates (block 104) aligned destination string addresses for both aligned and misaligned strings and then performs (block 106) aligned accesses to the memory 40 to retrieve both aligned and misaligned source strings. The processor 30 then performs (block 108) one or more operations on the source strings to generate the destination strings, as depicted in block 108. Subsequently, the dynamic binary translator 22 performs aligned accesses to store both aligned and misaligned destination strings in the memory 40, as depicted in block 110.

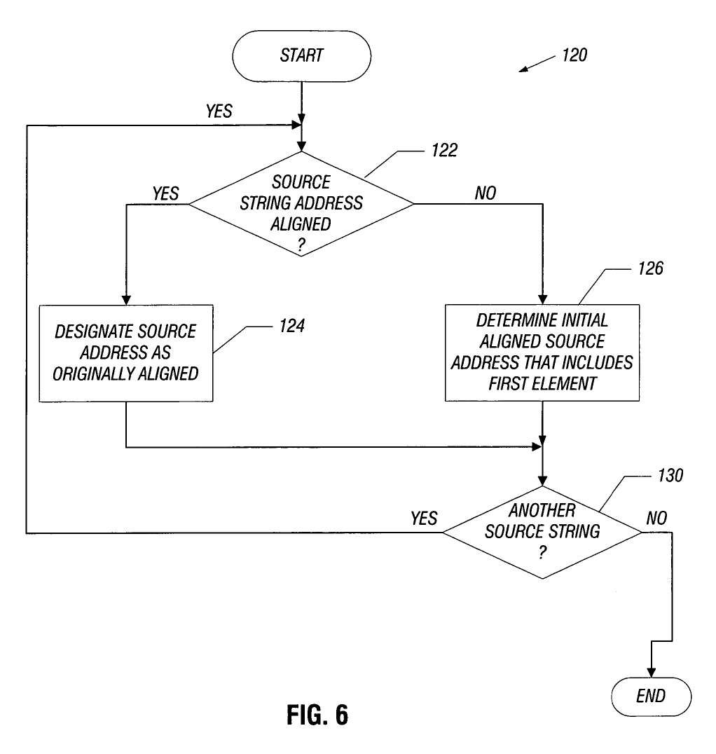

As a more specific example, FIG. 6 depicts a technique 120 that the binary translator 22 uses to process the source addresses, in accordance with some embodiments of the invention. Referring to FIG. 6 in conjunction with FIG. 2, pursuant to the technique 120, the dynamic binary translator 22 determines (diamond 122) whether the source string address is aligned. If so, then the dynamic binary translator designates (block 124) the source address as being an originally aligned address, pursuant to block 124. If the source string address is misaligned, then the dynamic binary translator 22 determines (block 126) the initial aligned source address that includes the first element of the source string.

More specifically, in the embodiments of the invention that are described below, for purposes of simplicity, it is assumed that each string occupies a contiguous memory space with the first element of the string being located in the lowest address of this contiguous memory space, and the last element of the string being located in the highest address of this contiguous memory space. Therefore, due to block 126, in view of the exemplary string 60 that is depicted in FIG. 3, the dynamic binary translator 22 selects the boundary address 52a as the initial aligned source address for the string 60.

Still referring to FIG. 6 in conjunction with FIG. 2, pursuant to the technique 120, after the dynamic binary translator 22 determines the initial aligned source address for the misaligned string, the translator 22 loads data from the initial aligned source address and stores it in a register called “RA[i].”

The RA[i] register (one of the registers 31 (FIG. 2), for example) is used in conjunction with a register called “RV[i]” to perform the pipeline operation in which the dynamic binary translator 22 aligns a misaligned string for purposes of storing the data in the string in the processor's register(s) 31. The index “i” points to the particular source string being processed. Thus, each source string is associated with a different value for i.

If the dynamic binary translator 22 determines (diamond 130) that another source string is to be processed, then control returns to diamond 122. Otherwise, all source string addresses have been processed for purposes of initializing the pipeline operations that are further described below.

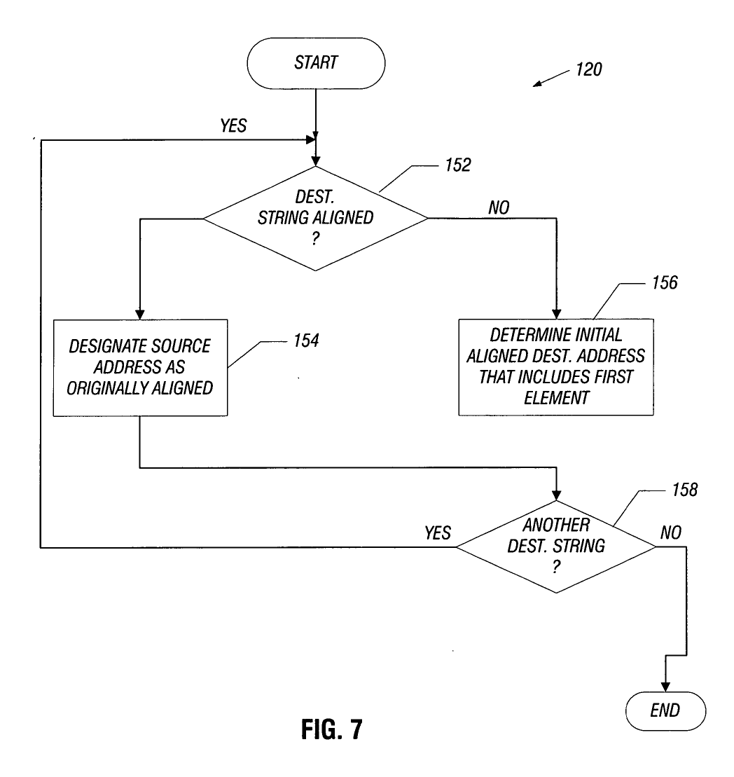

Referring to FIG. 7, in accordance with some embodiments of the invention, the dynamic binary translator 22 uses a technique 150 for purposes of initializing pipeline operations to process the destination via destination strings. Referring to FIG. 7 in conjunction with FIG. 2, pursuant to the technique 150, the dynamic binary translator 22 determines (diamond 152) whether the next destination string being processed is aligned, and if so, the dynamic binary translator 22 designates (block 154) the destination address as being originally aligned, pursuant to block 154. If, however, the destination string is misaligned, then the dynamic binary translator 22 determines (block 156) the initial aligned destination address that includes the first element of the destination string. If the dynamic binary translator 22 determines (diamond 158) that another destination string is to be processed, control then returns to diamond 152.

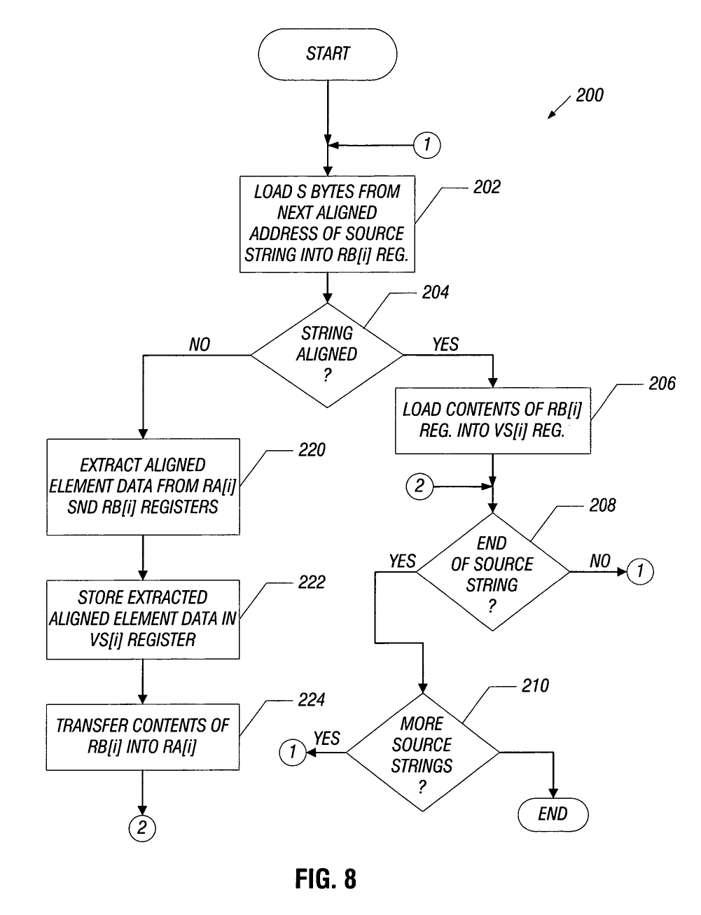

FIG. 8 depicts a technique 200 that the dynamic binary translator 22 uses for purposes of loading aligned and misaligned source strings from the memory 40 and storing these strings in a processor register 31 called “VS[i].” The VS[i] register contains the source string used by the processor 30 when performing an operation to produce one or more destination strings. If the source string is aligned, then the dynamic binary translator 22 loads each source string from memory 40 directly into the VS[i] register. However, if the source string is misaligned, then the dynamic binary translator 22 performs a pipeline operation (using the RA[i] and RB[i] registers) for purposes of aligning the contents of the misaligned source string in the VS[i] register. Pursuant to the technique 120 (FIG. 6) discussed above, the source string address is processed pursuant to the technique 200 are aligned: some of these addresses are associated with aligned source string addresses, and other aligned addresses are associated with misaligned source strings.

Referring to FIG. 8 in conjunction with FIG. 2, pursuant to the technique 200, the dynamic binary translator 22 loads S bytes from the next aligned address of a source string into the RB[i] register, pursuant to block 202. “S” represents the size (in bytes) of each element of the source string. Thus, as a more specific example, in some embodiments of the invention, S may be equal to two bytes. However, other element sizes are possible in other embodiments of the invention.

Subsequent to the loading of the RB[i] register, the dynamic binary translator determines (diamond 204) whether the source string being processed was originally aligned. If the dynamic binary translator 22 determines (diamond 204) that the string address was originally aligned, then the translator 22 loads (block 206) the S bytes into the VS[i] register, pursuant to block 206. The dynamic binary translator 22 then determines (diamond 208) whether the end of the source string has been reached. If not, the dynamic binary translator 22 then proceeds to block 202. Otherwise, if the end of the source string has been reached, the dynamic binary translator 22 then determines (diamond 210) whether more source strings are to be processed. If not, then the technique 200 ends. Otherwise, control proceeds to block 202.

If in diamond 208 the dynamic binary translator 22 determines (204) that the source string being processed is misaligned, the dynamic binary translator 22 begins a pipeline operation in which the translator 22 aligns the elements of the string in the VS[i] register. More specifically, the dynamic binary translator extracts (block 220) aligned element data from the RA[i] and RB[i] registers, pursuant to block 220. As a more specific example, referring back to FIG. 3 for the exemplary string 60, during the first iteration, memory unit E1 is stored in the RA[i] register, and memory units E2, E3, E4 and E5 are stored in the RB[i] register. The extraction of block 220 involves extracting memory unit E1 from the RA[i] register and extracting elements E2, E3 and E4 from the RB[i] register.

Still referring to FIG. 8 in conjunction with FIG. 2, pursuant to the technique 200, the dynamic binary translator proceeds from block 220 to store the extracted aligned element data in the VS [i] register, as depicted in block 222. Subsequently, the dynamic binary translator 22 initialized the next iteration of the pipeline operation by transferring the contents of the RB[i] register into the RA[i] register, as depicted in block 224. Control then proceeds from block 224 to diamond 208.

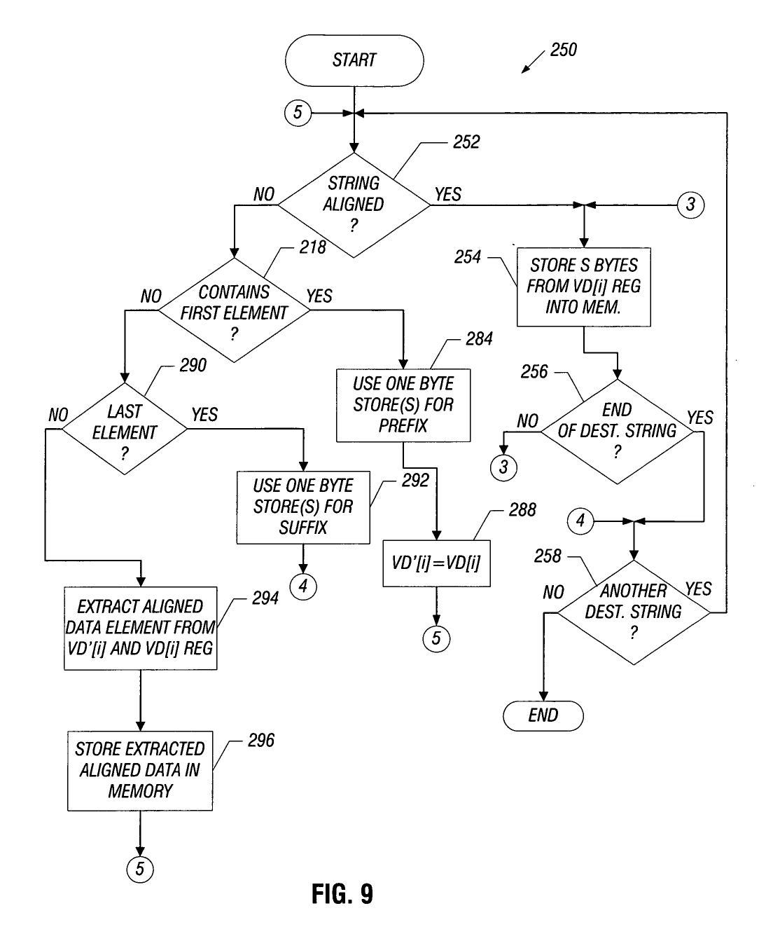

FIG. 9 depicts a technique 250 that is used by the dynamic binary translator 22, in some embodiments of the invention, for purposes of transferring data from a register called “VD[i]” (one of the registers 31 (FIG. 2), for example), which stores the results of the operation performed in response to the source strings. Referring to FIG. 9 in conjunction with FIG. 2, pursuant to the technique 250, the dynamic binary translator 22 determines (diamond 252) whether the destination string being currently processed is aligned. If so, then the dynamic binary translator 22 stores (block 254) S bytes from the VD[i] register into the memory 40, pursuant to block 254. The dynamic binary translator 22 then determines (diamond 256) whether the end of the current destination string has been reached, and if so, the dynamic binary translator 22 determines (diamond 258) whether another destination string is to be processed. If so, control returns the diamond 252. Otherwise, the dynamic binary translator 22 ends the technique 250. If, however, the dynamic binary translator 22 determines (diamond 256) that the end of the destination string has not been reached, then the translator 22 returns to block 254.

If the current destination string being processed by the dynamic binary translator 22 is misaligned, then the dynamic binary translator 22 maximizes the number of full width accesses to the memory 40 for purposes of storing the elements of the destination string. The rest of the operations may be one byte operations, in some embodiments of the invention. Thus, pursuant to the technique 250, the dynamic binary translator 22 determines (block 280) whether the S bytes being processed contains the first element of the misaligned destination string. If so, then the dynamic binary translator 22 uses the (block 284) one byte stores(s) for the prefix of the destination string, as depicted in block 284. Subsequently, the dynamic binary translator 22 initializes a pipeline register called “VD′[i]” by transferring the contents of the VD[i] register into the VD′[i] register, pursuant to block 288. Control then proceeds to diamond 252.

If the current S bytes being processed by the dynamic binary translator 22 does not contain the first element, then the dynamic binary translator determines (diamond 290) whether the S bytes contain the last element of the destination string. If so, the dynamic binary translator 22 then uses (block 292) one byte store(s) for the suffix of the destination string and control proceeds to diamond 258.

If, however, the dynamic binary translator 22 determines (diamond 290) that the current S bytes does not contain the last element (pursuant to diamond 290), then the dynamic binary translator 22 extracts (block 294) the aligned data element from the VD′[i] and VD[i] registers, and stores (block 296) the extracted aligned data in the memory 40 using a full width memory write operation. Control then proceeds to diamond 252.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
performing multiple aligned accesses to a memory to retrieve data of a string misaligned with respect to boundaries of the memory by an offset;
based on the offset, selecting a subset of the data; and
storing the subset in a register.

2. The method of claim 1, wherein each of the multiple aligned accesses comprises a multiple byte access.

3. The method of claim 1, wherein each of the multiple aligned accesses retrieves data that spans entirely between adjacent memory boundaries of the memory.

4. The method of claim 1, wherein the performing comprises pipelining data from the multiple accesses.

5. The method of claim 1, wherein the subset has a size equal to a size of data located between adjacent memory boundaries of the memory.

6. The method of claim 1, wherein the selecting comprises excluding data obtained from the multiple aligned accesses.

7. The method of claim 1, further comprising:
pipelining the data obtained from the multiple aligned accesses.

8. The method of claim 1, further comprising:
performing a scalar operation using the subset stored in the register.

9. The method of claim 8, further comprising:
accessing the memory to store another string produced by the operation.

10. A method comprising:
receiving a string misaligned with respect to address boundaries of a memory by an offset; and
based on the offset, dividing the data into subsets and storing the subsets in the memory using aligned accesses.

11. The method of claim 10, wherein the storing comprises performing aligned accesses to the memory to store at least some of the subsets.

12. The method of claim 11, wherein the subsets comprises one or more first subsets associated with single byte store operations to the memory and one or more second subsets associated with full data width store operations to the memory.

13. The method of claim 12, wherein said one or more subsets comprise one or more subsets located at the beginning of the string.

14. The method of claim 12, wherein said or more subsets comprise one or more subsets located at the end of the string.

15. A system comprising:
a dynamic random access memory having boundaries; and
a processor comprising a register to store at least part of a string misaligned with respect to the boundaries by an offset, the processor to, based on the offset, divide the data into subsets and store the subsets in the memory using aligned accesses.

16. The system of claim 15, wherein the processor performs aligned accesses to the memory to store at least some of the subsets in the memory.

17. The system of claim 15, wherein the subsets comprises one or more first subsets associated with single byte store operations to the memory and one or more second subsets associated with full data width store operations to the memory.

18. An article comprising a computer accessible storage medium storing instructions to, when executed, cause a processor-based system to:
perform multiple aligned accesses to a memory to retrieve data of a string misaligned with respect to boundaries of the memory by an offset;
based on the offset, select a subset of the data; and
store the subset in a register.

19. The article of claim 18, wherein each of the multiple aligned accesses comprises a multiple byte access.

20. The article of claim 18, wherein each of the multiple aligned accesses retrieves data that spans entirely between adjacent memory boundaries of the memory.

21. The article of claim 18, the storage medium storing instructions to when executed cause the processor-based system to pipeline data retrieved by the multiple aligned accesses.

22. An article comprising a computer accessible storage medium storing instructions to, when executed, cause a processor-based system to:
recognize an offset of a string stored in a register with respect to boundaries of a memory; and
based on the offset, divide the data into subsets and storing the subsets in the memory using aligned accesses.

23. The article of claim 22, the storage medium storing instructions to when executed cause the processor-based system to perform aligned accesses to the memory to store at least some of the subsets in the memory.

24. The article of claim 22, wherein the subsets comprises one or more first subsets associated with single byte store operations to the memory and one or more second subsets associated with full data width store operations to the memory.
